(19) United States
(12) Patent Application Publication
(10) Pub. No.: US 2025/0286591 A1
(43) Pub. Date: Sep. 11, 2025

(54) CHANNEL MEASUREMENT RESOURCE CONFIGURATION TO SUPPORT MULTI-TRP COHERENT JOINT TRANSMISSION CHANNEL STATE INFORMATION FEEDBACK

(71) Applicant: APPLE INC., Cupertino, CA (US)

(72) Inventors: Haitong Sun, Cupertino, CA (US); Dawei Zhang, Saratoga, CA (US); Louay Jalloul, San Jose, CA (US); Wei Zeng, San Diego, CA (US); Yushu Zhang, Beijing (CN); Ismael Gutierrez Gonzalez, San Jose, CA (US); Ghaith N Hattab, Santa Clara, CA (US); Weidong Yang, San Diego, CA (US); David Neumann, Munich (DE); Anchit Malhotra, Santa Clara, CA (US); Konstantinos Sarrigeorgidis, Los Gatos, CA (US)

(21) Appl. No.: 18/858,951

(22) PCT Filed: Apr. 26, 2023
(86) PCT No.: PCT/US2023/066247

§ 371 Date: Oct. 22, 2024

Related U.S. Application Data
(60) Provisional application No. 63/363,760, filed on Apr. 28, 2022.

(51) Int. Cl. H04B 7/06; H04B 7/024; H04B 7/0417; H04L 5/00

(52) U.S. Cl. CPC H04B 7/0626; H04B 7/024; H04B 7/0417; H04L 5/0035; H04L 5/0053

(57) ABSTRACT

Apparatus and methods are provided for TRP mapping configuration when a user equipment (UE) communicates with a plurality of transmission and reception points (TRPs). For multiple TRP (multi-TRP) coherent joint transmission (CJT) channel state information (CSI) reporting, a channel measurement resource (CMR) configuration may use CSI-RS port splitting, CSI-RS resource set splitting, or multiple CSI-RS resource sets.

### TECHNICAL FIELD

This application relates generally to wireless communication systems, including multiple TRP (multi-TRP) coherent joint transmission (CJT) channel state information (CSI) reporting.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a PMI matrix (codebook) used in certain embodiments herein.

FIG. 2 illustrates multi-TRP operation that may be used according to certain embodiments disclosed herein.

FIG. 3 illustrates a table showing possible antenna arrangements based on a number of CSI-RS ports in accordance with one embodiment.

FIG. 4 illustrates an embodiment in which the network configures which NZP-CSI-RS-Resources in NZP-CSI-RS-ResourceSet share the same TRP in accordance with one embodiment.

FIG. 5 illustrates multiple groups of NZP-CSI-RS-Resource in the NZP-CSI-RS-ResourceSet in accordance with one embodiment.

FIG. 6 illustrates a CSI report with multiple resource sets where each resource set is associated with a different TRP in accordance with one embodiment.

FIG. 7 illustrates a CSI report with multiple resource sets where each resource set comprises a group of CSI-RS resource each belonging to a different TRP in accordance with one embodiment.

FIG. 8 illustrates a flow chart of a method for a network node in accordance with one embodiment.

FIG. 9 illustrates a flow chart of a method for a user equipment in accordance with one embodiment.

FIG. 10 illustrates an example architecture of a wireless communication system, according to embodiments disclosed herein.

FIG. 11 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Many wireless communication standards provide for the use of known signals (e.g., pilot or reference signals) for a variety of purposes, such as synchronization, measurements, equalization, control, etc. For example, in cellular wireless communications, a reference signal (RS) may be provided to deliver a reference point for downlink power. When a wireless communication device or mobile device (i.e., UE) attempts to determine downlink power (e.g., the power of the signal from a base station, such as eNB for LTE and gNB for NR), it measures the power of the reference signal and uses it to determine the downlink cell power. The reference signal also assists the receiver in demodulating the received signals. Since the reference signals include data known to both the transmitter and the receiver, the receiver may use the reference signal to determine/identify various characteristics of the communication channel. This is commonly referred to as channel estimation, which is used in many high-end wireless communications such as LTE and 5G-NR communications. Known channel properties of a communication link in wireless communications are referred to as channel state information (CSI), which provides information indicative of the combined effects of, for example, scattering, fading, and power decay with distance. The CSI makes it possible to adapt transmissions to current channel conditions, which is useful for achieving reliable communications with high data rates in multi-antenna systems.

Oftentimes multi-antenna systems use precoding for improved communications. Precoding is an extension of beamforming to support multi-stream (or multi-layer) transmissions for multi-antenna wireless communications and is used to control the differences in signal properties between the respective signals transmitted from multiple antennas by modifying the signal transmitted from each antenna according to a precoding matrix. In one sense, precoding may be considered a process of cross coupling the signals before transmission (in closed loop operation), to equalize the demodulated performance of the layers. The precoding matrix is generally selected from a codebook that defines multiple precoding matrix candidates, wherein a precoding matrix candidate is typically selected according to a desired performance level based on any of a number of different factors such as current system configuration, communication environment, and/or feedback information from the receiver (e.g., UE) receiving the transmitted signal(s).

The feedback information is used in selecting a precoding matrix candidate by defining the same codebook at both the transmitter and the receiver, and using the feedback information from the receiver as an indication of a preferred precoding matrix. In such cases the feedback information includes what is referred to as a precoding matrix index (PMI), which can be based on properties of the signals received at the receiver. For example, the receiver may determine that a received signal has relatively low signal-to-noise ratio (SNR), and may accordingly transmit a PMI that would replace a current precoding matrix with a new precoding matrix to increase the signal-to-noise ratio (SNR).

In 3GPP NR systems, two types of codebook, Type I codebook and Type II codebook, have been standardized for CSI feedback in support of advanced MIMO operations. The two types of codebook are constructed from a two-dimensional (2D) discrete Fourier transform (DFT) based grid of beams, enabling CSI feedback of beam selection and phase shift keying (PSK) based co-phase combining between two polarizations. Type II codebook based CSI feedback also reports the wideband and subband amplitude information of the selected beams, allowing for more accurate CSI to be obtained. This, in turn, provides improved precoded MIMO transmissions over the network.

For multi-user multiple-in multiple-out (MIMO) systems, a base station may configure multiple UEs (e.g. two UEs) to report their precoding matrices, or precoding matrix candidates in mutually orthogonal directions. To reduce the CSI computation complexity for the UE, a base station may remove from consideration, based on uplink measurements, certain unlikely beams, thereby allowing the UE to not test the precoders formed by those beams that were removed from consideration. In other words, in order to reduce computation complexity, based on UL measurements the base station can restrict the UE to narrow the search space. Thus, the UE does not have to consider the entire codebook.

For 3GPP Release-15 (Rel-15) Type II port selection codebook, a beam-formed channel state information reference signal (CSI-RS) exploits downlink (DL) and uplink (UL) channel reciprocity. For example, the base station estimates the UL channel and, based on channel reciprocity, acquires the channel state information regarding the DL channel. Then, based on the DL channel information, the base station precodes different ports in CSI-RS differently for the UE to perform further CSI reporting for CSI refinement. The UE measures CSI-RS and provides feedback to the base station. For a total number X of CSI-RS ports, X/2 ports are horizontally polarized (H-pol) and X/2 ports are vertically polarized (V-pol). L CSI-RS ports are selected out of X/2 CSI-RS ports. The first CSI-RS port may be selected every d ports (e.g., d is either 1 or 2 or 3 or 4). Then, consecutive L (e.g., 1, 2, 4) ports are selected with wrap around.

3GPP Rel-16 Type II port selection codebook enhancement uses the same port selection design as 3GPP Rel-15. When subband PMI is configured, a frequency domain DFT matrix can be used to compress the linear combination coefficients.

For Type II port selection codebook, it may be assumed that the base station will precode the CSI-RS based on channel reciprocity (i.e., DL channel estimated based on UL channel). For frequency division duplexing (FDD), exact channel reciprocity may not exist, especially when the duplexing distance is large. However, even for FDD, partial reciprocity may still exist when, for example, the angle of arrival or departure is similar between DL and UL carriers and/or the channel delay profile is similar between DL and UL carriers.

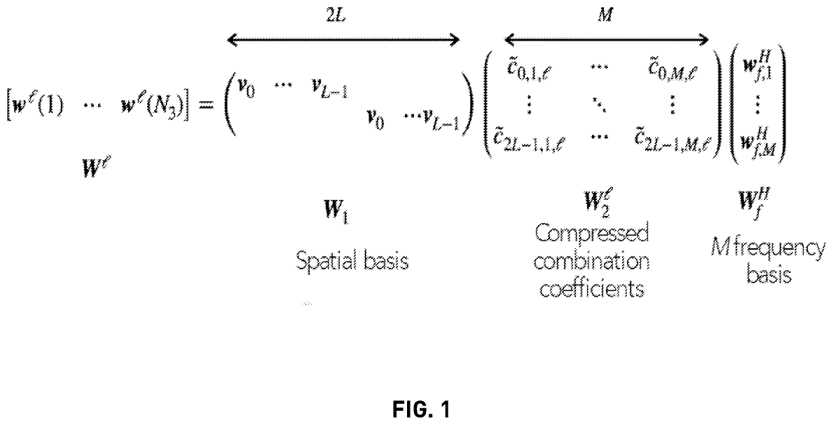

FIG. 1 illustrates a PMI matrix (codebook) used in certain embodiments herein. In the illustrated example, a Type II port selection codebook structure is given by W^{l}=W₁*W₂^{l}*W_{f}^{H} (also notated for simplicity herein as W=W₁*W₂*W_{f} or W=W1W2Wf), where W is the PMI matrix (also referred to herein simply as codebook), W₁ is a spatial basis selection matrix (also referred to herein as a port selection matrix W₁), W₂ provides compressed combination coefficients, W_{f} is a frequency basis selection matrix, l is a layer index, N₃ is the number of PMI subbands, L is the number of selected ports, M is the number of frequency basis, and H denotes a Hermitian matrix or conjugate transpose operation. For simplicity, “W_{f}” or “Wf” assumes that the Hermitian operation has already been performed.

In certain systems, for port selection codebook enhancements utilizing DL/UL reciprocity of angle and/or delay, support is provided for codebook structure W=W₁*W₂*W_{f} where the port selection matrix W₁ is a free selection matrix, with the identity matrix as a special configuration. The frequency basis selection matrix W_{f} is a DFT based compression matrix in which N₃=N_{CQISubband}*R and Mv>=1, where R is a size of the channel quality indicator (CQI) subband divided by the size of the PMI subband, and Mv is the number of selected frequency basis. N₃ is the number of PMI subbands for frequency basis selection. At least one value of Mv>1 may be supported. In certain such systems, value(s) of My may be decided (e.g., Mv=2). In other embodiments, support of Mv>1 is a UE optional feature, taking into account UE complexity related to codebook parameters. However, candidate value(s) of R, mechanisms for configuring/indicating to the UE and/or mechanisms for selecting/reporting by UE for W_{f} have yet to be determined. In addition, or in other systems, W_{f} can be turned off by the base station. When turned off, W_{f} may be an all-one vector.

In Rel-15, Type II and Type II port selection codebook is specified based on W₁*W₂. In Rel-16, enhanced Type II and Type II port selection codebook is specified based on W₁*W₂*W_{f}.

In Rel-17, further enhanced Type II port selection codebook is specified. For example, CSI feedback in Rel-17 is further enhanced for non-coherent joint transmission (NCJT) for multiple transmission and reception point (TRP) operation (referred to as multi-TRP or mTRP). In certain wireless networks, NCJTs may be used to provide multiple-input multiple-output (MIMO), multiple-user (MU) MIMO, and/or coordinated multi-point (CoMP) communications. The NCJTs may be from multi-TRP, multiple panels (multi-panels) of a TRP, or a combination thereof. Coherent joint transmission (CJT) uses synchronization among TRPs. However, for distributed TRPs, the precoders may not be jointly designed and such that the TRPs are not synchronized. Instead, each TRP derives the precoder independently without knowledge of the precoders used by the other TRPs. Thus, the joint transmission is non-coherent. In Rel-17, CSI feedback for NCJT for multi-TRPs is based on Type I MIMO codebook, which only supports single downlink control information (DCI) multi-TRP NCJT scheme 1a (i.e., spatial domain multiplexing)).

In certain communication systems (e.g., Rel-18 NR), it may be desirable to provide CSI enhancement to support CJT for multi-TRP. CJT assumes that multiple TRPs can jointly precode the transmission in a coherent way. Certain such systems may, for example, target frequency range 1 (FR1) and up to four TRPs, assuming an ideal backhaul and synchronization as well as the same number of antenna ports across TRPs, as follows: Rel-16/17 Type II codebook refinement for CJT mTRP targeting FDD and its associated CSI reporting, taking into account throughput-overhead tradeoff. In current standards a UE only reports a CSI for one TRP for coherent transmission.

Embodiment herein provide support for a CSI report for CJT for multi-TRP CSI for up to multiple TRPs (e.g., four TRPs). In order to support CSI for CJT for multi-TRP, a network may provide the UE with a channel measurement resource (CMR) configuration that identifies how a CMR should be associated with each TRP. The network node may configure a resource set and within that set configure multiple resources and within that resources multiple ports.

In NR, CSI is configured in CSI-ReportConfig. A CMR resource is configured in the CSI-ResourceConfig. For periodic and semi-persistent CSI, the carrier field in CSI-ReportConfig indicates the serving cell that contains the CMR. Further, the resourcesForChannelMeasurement indicates which CMR resource set in CSI-ResourceConfig contains the CMR. For aperiodic CSI the CMR is additionally indicated in CSI-AssociatedReportConfigInfo.

CSI reports for the multi-TRP may be done at any level of the CMR hierarchal structure (e.g., multiple resource sets, resources within a resource set, or ports within the resources). For example, the CMR configuration may use CSI-RS port splitting, CSI-RS resource set splitting, and/or multiple CSI-RS resource sets. For CSI-RS port splitting, in one embodiment, each resource may include multiple ports (e.g., up to thirty-two ports). The network may assign different ports to different TRPs. The network may indicate to the UE that a first channel measurement should belongs to a first TRP and a second channel measurement should belong to a second TRP. In some embodiments, the network may use CSI-RS resource set splitting by associating all the ports in a resource with on TRP and all the ports in other resources with different TRPs. In some embodiments, the network may also use multiple CSI-RS resource sets and associate different TRPs with each of the CSI-RS resource sets.

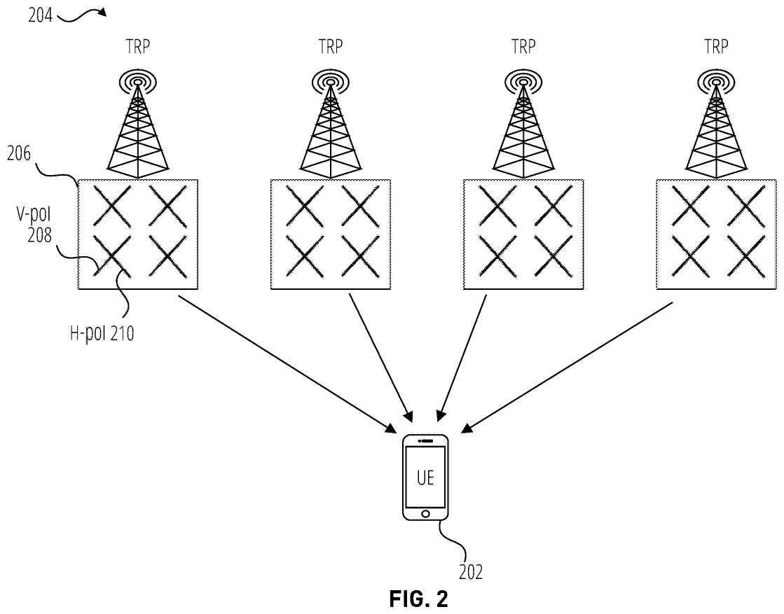

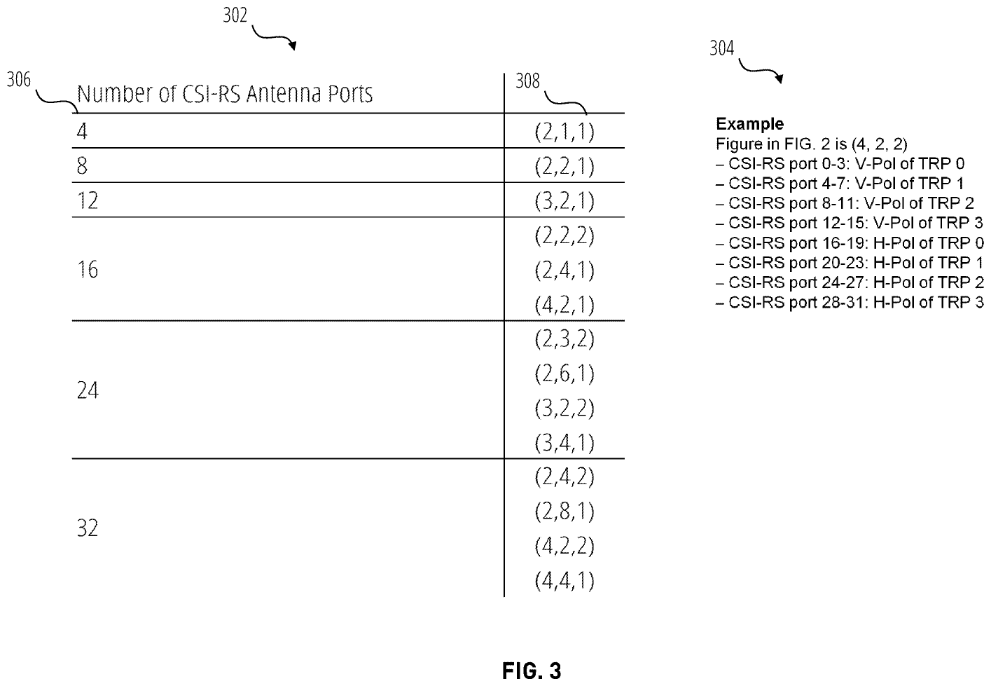

FIG. 2 illustrates multi-TRP operation that may be used according to certain embodiments disclosed herein. A UE 202 receives signals from four TRPs 204. Each TRP includes an antenna panel 206 that has eight ports (i.e., antenna elements), wherein four of the ports are V-pol and four of the ports are H-pol. For example, a cross-polarized antenna may include a V-pol port 208 and an H-pol port 210. Thus, the four TRPs 204 use a combined total of 32 ports. CSI-RS port splitting may be used for port to TRP mapping for CMR configuration for Multi-TRP CJT.

In some embodiments for CMR configuration for Multi-TRP CJT, each CSI report configuration (e.g., CSI-ReportConfig) is associated with only one resources set (e.g., NZP-CSI-RS-ResourceSet). Further, each resources set (e.g., NZP-CSI-RS-ResourceSet) may contain one or multiple resources (e.g., NZP-CSI-RS-Resource). Additionally, each resources (e.g., NZP-CSI-RS-Resource) may contain multiple ports. In these embodiments, multiple ports of one or more resources of a single resource set may be mapped to the TRPs 204.

Ports to TRP mapping for each of the one or more resources (e.g., NZP-CSI-RS-Resource) may be hard coded and/or configured by the network. Ports to TRP mapping indicates which ports belong to the same TRP. In some embodiments, the ports to TRP mapping for the resources is hard coded in the specification based on a limited number of deployment choices. In some embodiments, the ports to TRP mapping for the resources is configured by the network node by radio resource control (RRC) signaling or Medium Access Control (MAC) control element (CE). In some embodiments, the ports to TRP mapping is configured by a combination of hard coded deployment choices and configuration by the network. For example, several deployment choices may be hard coded in the specification and a network node may use RRC signaling or MAC CE to indicate to the UE which deployment choice to use.

FIG. 3 illustrates an example of a CMR configuration for Multi-TRP CJT using CSI-RS port splitting on a single resource in accordance with one embodiment. In the illustrated embodiment, the ports to TRP mapping is hardcoded in the specification. The UE and network node may both use a pre-defined port to TRP mapping configuration for each antenna arrangement 308 for each NZP-CSI-RS-Resource.

The port to TRP mapping configuration may be determined by the UE and network node based on the antenna arrangement 308. The antenna arrangement 308 is defined by three factors (N_{g}, N₁, and N₂). N_{g} is the number of TRPs, N₁ is the number of V-Pol/H-Pol pairs vertically per TRP, and N₂ is the number of V-Pol/H-Pol pairs horizontally per TRP. Accordingly, the UE and network node may determine the port to TRP mapping configuration based on those three factors.

FIG. 3 includes a table 302 showing all possible antenna arrangements based on a number of CSI-RS ports 306. For each number of CSI-RS ports 306 one or more antenna arrangement 308 is possible. For example, for a network system that includes four ports across multiple TRPs, there is only one arrangement (i.e., (2, 1, 1)). In this arrangement there are two TRPs, each TRP has one element, and each element has V-Pol/H-Pol pairs.

As another example, a network system with 32 ports may use two or four TRPs. In the case of using two TRPs the antenna panel for each TRP can be arranged with either four vertical V-Pol/H-Pol pairs and two horizontal V-Pol/H-Pol pairs, or eight vertical V-Pol/H-Pol pairs and one horizontal V-Pol/H-Pol pairs. The network may indicate to the UE which antenna arrangement 308 is used when there are more than one option.

For each antenna arrangement 308, there may be a hard coded ports to TRP mapping configuration. For example, ports to TRP mapping 304 illustrates an embodiment of a mapping for a (4, 2, 2) antenna arrangement. The (4, 2, 2) antenna arrangement is the arrangement shown in FIG. 2. The network node may configure one resource set with one or more resources, the one or more resources can have multiple ports. The network node may inform the UE of the number of ports and the antenna arrangement 308. The UE uses the ports to TRP mapping 304 to determine which TRP is using which port.

As shown, the ports to TRP mapping 304 may divide the 32 ports into four groups, with each group containing eight ports. The groups of ports may be associated with the TRPs. For example, in the illustrated ports to TRP mapping 304, CSI-RS ports 0-3 are associated with the V-Pol of TRP 0, CSI-RS ports 4-7 are associated with the V-Pol of TRP 1, and so on. The UE may measure and provide a CSI report for the CSI resource set based on the ports to TRP mapping 304.

For CMR configuration for Multi-TRP CJT, for each NZP-CSI-RS-Resource, the ports to TRP mapping (e.g., ports to TRP mapping 304) may be partially configured by the network. For example, in some embodiments, a network node only configures the N_{g} and N₁ parameters, and the ports to TRP mapping is determined sequentially. Note that the N₂ can be inferred by the UE from the total number of CSI-RS ports (i.e., P_{CSI-RS}) and N_{g} and N₁. For example, N₂ can be inferred based on the following equation: N₂=P_{CSI-RS}/2/N_{g}/N₁. The sequential determination of the ports to TRP mapping may cause a first portion of the CSI-RS ports to be mapped to a first TRP, a second portion of the CSI-RS ports to be mapped to a second TRP, and so on. In other words, each group of CSI-RS ports are assigned in sequential order to the TRPs.

For example, in some embodiments, in the first P_{CSI-RS}/2 CSI-RS ports, the first N₁*N₂ ports belongs to the V-pol of the first TRP and the next N₁*N₂ ports belongs to the V-pol of the second TRP, etc. Further, in the last P_{CSI-RS}/2 CSI-RS ports, the first N₁*N₂ ports belongs to the H-pol of the first TRP and the next N₁*N₂ ports belongs to the H-pol of the second TRP, etc.

In some embodiments, the CSI-RS port to TRP mapping can be explicitly configured by the network node. The CSI-RS port to TRP mapping may not always be sequential. Using two TRPs with eight ports as an example, port (0, 2) may map to the V-Pol of the first TRP, port (4, 6) may map to the H-Pol of the first TRP, port (1, 3) may map to the V-Pol of the second TRP, port (5, 7) may map to the H-Pol of the second TRP.

In some embodiments, the network may configure the ports to TRP mapping for CMR configuration for Multi-TRP CJT for each CSI-RS resource (e.g., NZP-CSI-RS-Resource) to indicate which ports belong to the same TRP using existing groupings. For example, the network node may configure Code division multiplexing (CDM) groups for the CSI-RS ports. The UE and network node may associate the CSI-RS ports in a same CDM group with a same TRP.

For CMR configuration for Multi-TRP CJT, for each NZP-CSI-RS-Resource, the port or antenna configuration of each TRP has the following options. In some embodiments, the antenna configuration (e.g., antenna arrangement 308) of each TRP has to be the same. In other words, N₁ and N₂ are the same value for each TRP.

In some embodiments, the antenna configuration of each TRP can be different. In other words, N₁ and N₂ can be different for each TRP. For example a wireless communication system may comprise four TRs with a total of 32 ports. Some of the TRPs can have an antenna configuration of (N₁=4 and N₂=1), while other TRPs can have an antenna configuration of (N₁=2 and N₂=2). The network node may inform the UE of the different antenna configurations of the different TRPs.

Some embodiments may use CSI-RS resource set splitting. For CSI-RS resource splitting, one resource set may include one or more CSI-RS resources with multiple ports. Each CSI-RS resource may be associated with a TRP. In other words all the ports in one CSI-RS resource may be associated with a first TRP, and ports from additional resources may be associated with different TRPs. For instance, for CMR configuration for Multi-TRP CJT, each CSI-ReportConfig may be associated with only one NZP-CSI-RS-ResourceSet and each NZP-CSI-RS-ResourceSet may contain one or multiple NZP-CSI-RS-Resource, in some embodiments each different NZP-CSI-RS-Resource is associated with different TRP.

There are several ways the CSI-RS resource set may be divided for CSI-RS resource set splitting. The CSI-RS resource set splitting may be configured by the network. In some embodiments, the network may associate multiple CSI-RS resources with a TRP.

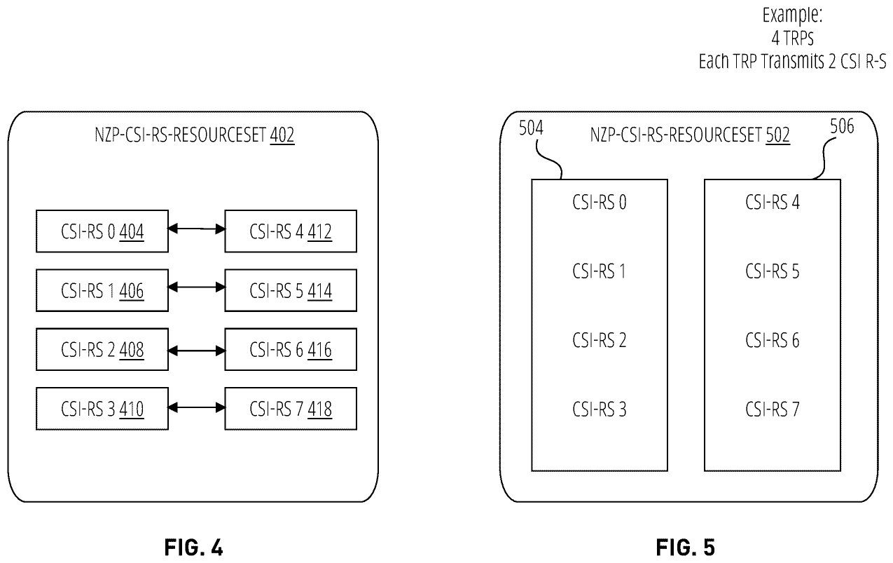

For example, FIG. 4 illustrates an embodiment in which the network configures which NZP-CSI-RS-Resources (e.g., CSI-RS 0 404, CSI-RS 1 406, CSI-RS 2 408, CSI-RS 3 410, CSI-RS 4 412, CSI-RS 5 414, CSI-RS 6 416, and CSI-RS 7 418) in NZP-CSI-RS-ResourceSet 402 share the same TRP. The network node may be able to flexibly assign multiple resources, such as the pairs illustrated, to a TRP. The network node may send a configuration informing the UE of which CSI-RS resources should be associated with which TRP. The UE may indicate a preferred CSI-RS for each TRP independently. The UE may, for example, send a CSI-RS Resource Indicator (CRI) in a CSI report.

For example, in the illustrated embodiment, a network node configures pairs of CSI-RS resources for a set of four TRPs. A first TRP is associated with CSI-RS 0 404 and CSI-RS 4 412. A second TRP is associated with CSI-RS 1 406 and CSI-RS 5 414. A third TRP is associated with CSI-RS 2 408 and CSI-RS 6 416. A fourth TRP is associated with CSI-RS 3 410 and CSI-RS 7 418.

The UE may measure the pairs of CSI-RS resources and report a preference of which CSI-RS resource should be used for each TRP. In some embodiments, for reporting the preferred CSI-RS (e.g., CRI in CSI report), UE selects CSI-RS for each TRP independently. For example, for the first TRP the UE may indicate a preference for CSI-RS 0 404, for the second TRP the UE may indicate a preference for CSI-RS 5 414, for the third TRP the UE may indicate a preference for CSI-RS 6 416, and for the fourth TRP the UE may indicate a preference for CSI-RS 3 410.

In some embodiments, the network may configure the CSI-RS resources into resource groups where each resource group comprises CSI-RS resources for each of the TRPs. For example, in FIG. 5 a network node is indicating multiple groups of NZP-CSI-RS-Resource (e.g., first group 504 and second group 506) in the NZP-CSI-RS-ResourceSet 502. Each group contains the NZP-CSI-RS-Resource from different TRP such that the group contains a CS-RS resource for each TRP. For reporting the preferred CSI-RS (e.g., CRI in CSI report), UE selects which group it prefers and notifies the network node.

For example, in the first group 504, a first TRP may be associated with CSI-RS 0, a second TRP may be associated with CSI-RS 1, a third TRP may be associated with CSI-RS 2, and a fourth TRP may be associated with CSI-RS 3. In the second group 506, the first TRP may be associated with CSI-RS 4, the second TRP may be associated with CSI-RS 5, the third TRP may be associated with CSI-RS 6, and the fourth TRP may be associated with CSI-RS 7. The network node may inform the UE of the configuration. The UE may report to the network node whether it prefers the first group 504 or the second group 506.

When the network indicates multiple groups of NZP-CSI-RS-Resource in NZP-CSI-RS-ResourceSet, each group may contain the NZP-CSI-RS-Resource from different TRP. In some embodiments, within the same group of NZP-CSI-RS-Resource, all NZP-CSI-RS-Resource may have to be configured with the same number of ports. In some embodiments across different groups of NZP-CSI-RS-Resource, all NZP-CSI-RS-Resource may have to be configured with the same number of ports. In some embodiments, different groups of NZP-CSI-RS-Resource can be configured with a different number of ports.

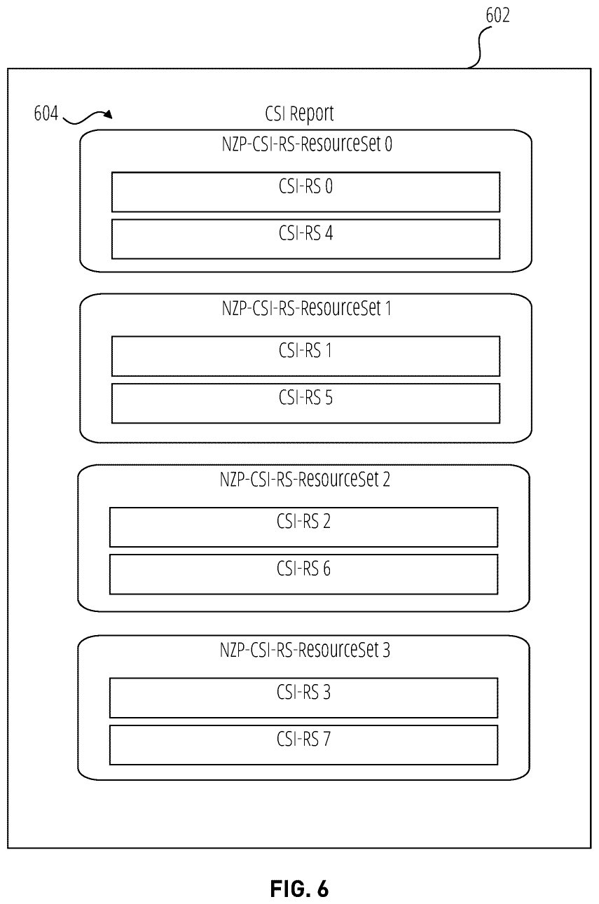

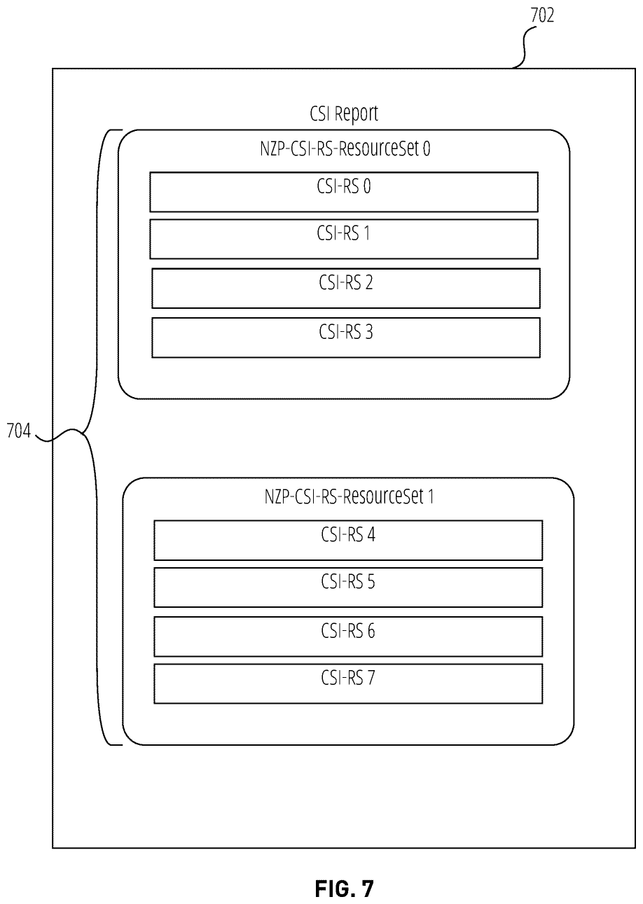

FIGS. 6 and 7 illustrate CSI reports using multiple CSI-RS resource sets for a CMR configuration for Multi-TRP CJT. These embodiments use the multiple CSI-RS resource sets to support the multiple TRPs. Thus, the multiple TRPs may be supported at the resource level.

More specifically, FIG. 6 illustrates a CSI report 602 with multiple resource sets 604 where each resource set is associated with a different TRP. In other words, for CMR configuration for Multi-TRP CJT, each CSI-ReportConfig may be associated with one or multiple NZP-CSI-RS-ResourceSet, and each NZP-CSI-RS-ResourceSet may be mapped to one TRP.

All resources within a resource set may be mapped to a single TRP. For example, in the illustrated embodiment, NZP-CSI-RS-ResourceSet 0 is mapped to TRP 0, NZP-CSI-RS-ResourceSet 1 is mapped to TRP 1, NZP-CSI-RS-ResourceSet 2 is mapped to TRP 2, and NZP-CSI-RS-ResourceSet 3 is mapped to TRP 3. In some embodiments, the multiple resource sets may be configured with the same number of resources and each resource may be configured with the same number of ports. For example, each of the four illustrated NZP-CSI-RS-ResourceSet may be configured with the same number of CSI-RS-Resource (e.g., two) and each CSI-RS-Resource may be configured with the same number of ports.

FIG. 7 illustrates a CSI report 702 with multiple resource sets 704 where each resource set comprises a group of CSI-RS resource each belonging to a different TRP. For example, in the illustrated embodiment, NZP-CSI-RS-ResourceSet 0 comprises CSI-RS 0, CSI-RS 1, CSI-RS 2, and CSI-RS 3. Each of the CSI-RS are from a different TRP. For example, CSI-RS 0 may be mapped to TRP 0, CSI-RS 1 may be mapped to TRP 1, CSI-RS 2 may be mapped to TRP 2, and CSI-RS 3 may be mapped to TRP 3. Similarly, NZP-CSI-RS-ResourceSet 1 comprises CSI-RS 4, CSI-RS 5, CSI-RS 6, and CSI-RS 7. Each of the CSI-RS are from a different TRP. For example, CSI-RS 4 may be mapped to TRP 0, CSI-RS 5 may be mapped to TRP 1, CSI-RS 6 may be mapped to TRP 2, and CSI-RS 7 may be mapped to TRP 3.

For both the embodiments illustrated in FIG. 6 and FIG. 7, the UE may indicate a preferred CSI-RS for the TRPs in multiple ways. In some embodiments, a different and independent index of CSI-RS can be reported by the UE for different resource sets (e.g., each NZP-CSI-RS-ResourceSet). For example, in FIG. 6 there are 16 possible combinations of CSI-RS. The UE may send a report for each possibility. In some embodiments, a single index of CSI-RS may be reported by the UE, in which NZP-CSI-RS-ResourceSet (TRP), the same CSI-RS index is selected. For example, the UE may indicate in FIG. 6 whether the first CSI-RS of every resource set is preferred or whether the second CSI-RS of every resource set is preferred.

In some embodiments, for CMR configuration for Multi-TRP CJT, for Type II CSI report, in each CSI-ReportConfig only one CSI-RS-Resource may be configured per TRP. In these embodiments, the UE does not report CRI in the Type II CSI. The selection of CSI-RS-Resource is automatic because there is only one resource for each TRP. This may reduce overhead and simplify UE implementation.

In some embodiments, each NZP-CSI-RS-ResourceSet shall have the same time domain behavior (e.g., periodic, or semi-periodic, or aperiodic). In other words, the CSI-RS resource sets may all be periodic, semi-periodic, or aperiodic. The time domain behavior may be configured by RRC.

In some embodiments, for CMR measurement for Multi-TRP CJT, CMRs from each of the different TRPs may have time domain restrictions. The time domain restrictions may make the transmission more time compact. In some embodiments, all CMRs from different TRPs have to be contained within the same CDRX active time. In some embodiments, all CMRs from different TRPs have to be contained within the same slot. In some embodiments, all CMRs from different TRPs have to be contained within a time domain window without duplexing direction change in between the transmissions from each of the TRPs.

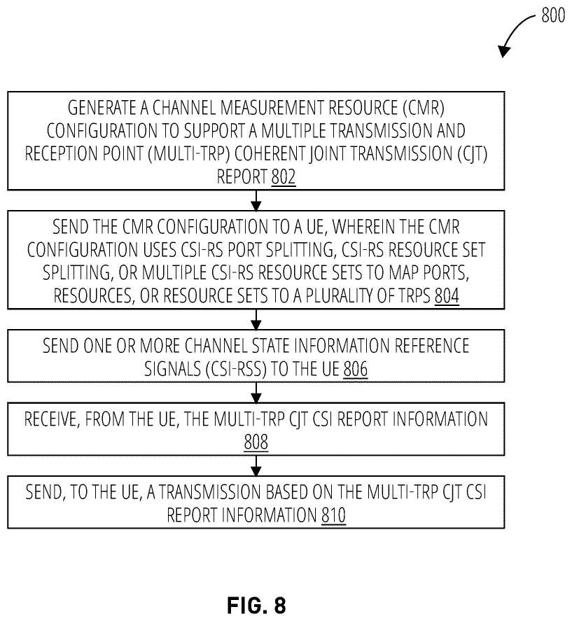

FIG. 8 illustrates a flow chart of a method 800 for a network node. The network node may generate 802 a CMR configuration to support a Multi-TRP CJT report. The CMR configuration may include features from embodiments discussed in the previous figures. The network node may send 804 the CMR configuration to a UE. The CMR configuration may use CSI-RS port splitting, CSI-RS resource set splitting, or multiple CSI-RS resource sets to map ports, resources, or resource sets to a plurality of TRPs as discussed with reference to the previous figures. The network node may send 806 one or more CSI-RSs to the UE. The network node may receive 808, from the UE, the multi-TRP CJT CSI report information. The network node may send 810, to the UE, a transmission (e.g., PDSCH), based on the multi-TRP CJT CSI report information.

Embodiments contemplated herein include an apparatus comprising means to perform one or more elements of the method 800. This apparatus may be, for example, an apparatus of a base station (such as a network device 1118 that is a base station, as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a base station (such as a memory 1122 of a network device 1118 that is a base station, as described herein).

Embodiments contemplated herein include an apparatus comprising logic, modules, or circuitry to perform one or more elements of the method 800. This apparatus may be, for example, an apparatus of a base station (such as a network device 1118 that is a base station, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a base station (such as a network device 1118 that is a base station, as described herein).

Embodiments contemplated herein include a signal as described in or related to one or more elements of the method 800.

Embodiments contemplated herein include a computer program or computer program product comprising instructions, wherein execution of the program by a processing element is to cause the processing element to carry out one or more elements of the method 800. The processor may be a processor of a base station (such as a processor(s) 1120 of a network device 1118 that is a base station, as described herein). These instructions may be, for example, located in the processor and/or on a memory of the base station (such as a memory 1122 of a network device 1118 that is a base station, as described herein).

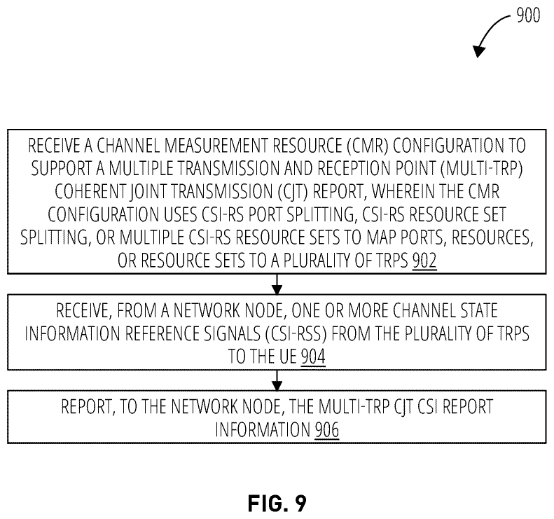

FIG. 9 illustrates a flow chart of a method 900 for a UE. The UE may receive 902 a CMR configuration to support a Multi-TRP CJT report. The CMR configuration may include features from embodiments discussed in the previous figures. For example, The CMR configuration may use CSI-RS port splitting, CSI-RS resource set splitting, or multiple CSI-RS resource sets to map ports, resources, or resource sets to a plurality of TRPs as discussed with reference to the previous figures. The UE may receive 904, from a network node, one or more CSI-RSs from the plurality of TRPs to the UE. The UE may report 906, to the network node, the multi-TRP CJT CSI report information. The CSI report may be structured as discussed with reference to the previous figures.

Embodiments contemplated herein include an apparatus comprising means to perform one or more elements of the method 900. This apparatus may be, for example, an apparatus of a UE (such as a wireless device 1102 that is a UE, as described herein).

Embodiments contemplated herein include one or more non-transitory computer-readable media comprising instructions to cause an electronic device, upon execution of the instructions by one or more processors of the electronic device, to perform one or more elements of the method 900. This non-transitory computer-readable media may be, for example, a memory of a UE (such as a memory 1106 of a wireless device 1102 that is a UE, as described herein).

Embodiments contemplated herein include an apparatus comprising logic, modules, or circuitry to perform one or more elements of the method 900. This apparatus may be, for example, an apparatus of a UE (such as a wireless device 1102 that is a UE, as described herein).

Embodiments contemplated herein include an apparatus comprising: one or more processors and one or more computer-readable media comprising instructions that, when executed by the one or more processors, cause the one or more processors to perform one or more elements of the method 900. This apparatus may be, for example, an apparatus of a UE (such as a wireless device 1102 that is a UE, as described herein).

Embodiments contemplated herein include a signal as described in or related to one or more elements of the method 900.

Embodiments contemplated herein include a computer program or computer program product comprising instructions, wherein execution of the program by a processor is to cause the processor to carry out one or more elements of the method 900. The processor may be a processor of a UE (such as a processor(s) 1104 of a wireless device 1102 that is a UE, as described herein). These instructions may be, for example, located in the processor and/or on a memory of the UE (such as a memory 1106 of a wireless device 1102 that is a UE, as described herein).

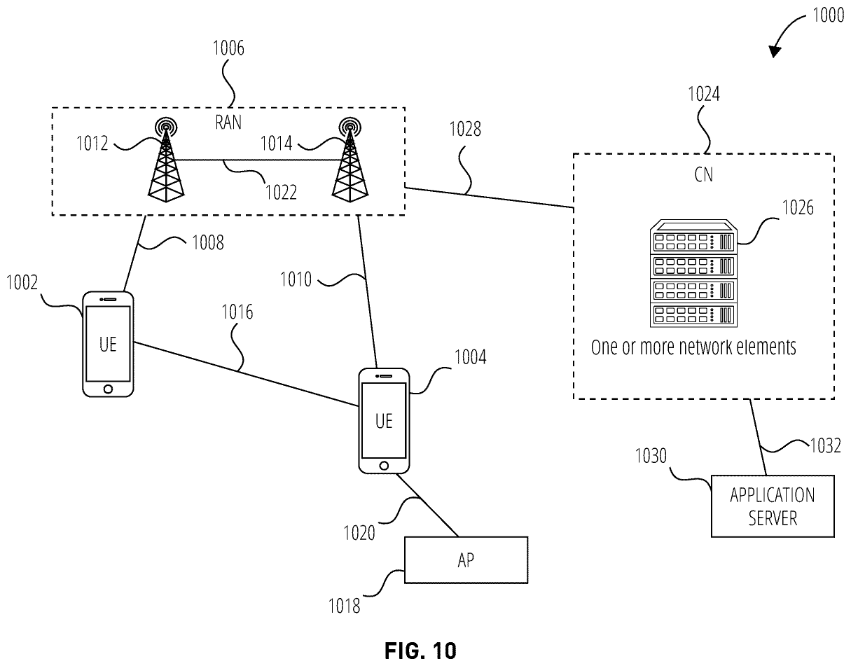

FIG. 10 illustrates an example architecture of a wireless communication system 1000, according to embodiments disclosed herein. The following description is provided for an example wireless communication system 1000 that operates in conjunction with the LTE system standards and/or 5G or NR system standards as provided by 3GPP technical specifications.

As shown by FIG. 10, the wireless communication system 1000 includes UE 1002 and UE 1004 (although any number of UEs may be used). In this example, the UE 1002 and the UE 1004 are illustrated as smartphones (e.g., handheld touchscreen mobile computing devices connectable to one or more cellular networks), but may also comprise any mobile or non-mobile computing device configured for wireless communication.

The UE 1002 and UE 1004 may be configured to communicatively couple with a RAN 1006. In embodiments, the RAN 1006 may be NG-RAN, E-UTRAN, etc. The UE 1002 and UE 1004 utilize connections (or channels) (shown as connection 1008 and connection 1010, respectively) with the RAN 1006, each of which comprises a physical communications interface. The RAN 1006 can include one or more base stations, such as base station 1012 and base station 1014, that enable the connection 1008 and connection 1010.

In this example, the connection 1008 and connection 1010 are air interfaces to enable such communicative coupling, and may be consistent with RAT(s) used by the RAN 1006, such as, for example, an LTE and/or NR.

In some embodiments, the UE 1002 and UE 1004 may also directly exchange communication data via a sidelink interface 1016. The UE 1004 is shown to be configured to access an access point (shown as AP 1018) via connection 1020. By way of example, the connection 1020 can comprise a local wireless connection, such as a connection consistent with any IEEE 802.11 protocol, wherein the AP 1018 may comprise a Wi-Fi® router. In this example, the AP 1018 may be connected to another network (for example, the Internet) without going through a CN 1024.

In embodiments, the UE 1002 and UE 1004 can be configured to communicate using orthogonal frequency division multiplexing (OFDM) communication signals with each other or with the base station 1012 and/or the base station 1014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1012 or base station 1014 may be implemented as one or more software entities running on server computers as part of a virtual network. In addition, or in other embodiments, the base station 1012 or base station 1014 may be configured to communicate with one another via interface 1022. In embodiments where the wireless communication system 1000 is an LTE system (e.g., when the CN 1024 is an EPC), the interface 1022 may be an X2 interface. The X2 interface may be defined between two or more base stations (e.g., two or more eNBs and the like) that connect to an EPC, and/or between two eNBs connecting to the EPC. In embodiments where the wireless communication system 1000 is an NR system (e.g., when CN 1024 is a 5GC), the interface 1022 may be an Xn interface. The Xn interface is defined between two or more base stations (e.g., two or more gNBs and the like) that connect to 5GC, between a base station 1012 (e.g., a gNB) connecting to 5GC and an eNB, and/or between two eNBs connecting to 5GC (e.g., CN 1024).

The RAN 1006 is shown to be communicatively coupled to the CN 1024. The CN 1024 may comprise one or more network elements 1026, which are configured to offer various data and telecommunications services to customers/subscribers (e.g., users of UE 1002 and UE 1004) who are connected to the CN 1024 via the RAN 1006. The components of the CN 1024 may be implemented in one physical device or separate physical devices including components to read and execute instructions from a machine-readable or computer-readable medium (e.g., a non-transitory machine-readable storage medium).

In embodiments, the CN 1024 may be an EPC, and the RAN 1006 may be connected with the CN 1024 via an S1 interface 1028. In embodiments, the S1 interface 1028 may be split into two parts, an S1 user plane (St-U) interface, which carries traffic data between the base station 1012 or base station 1014 and a serving gateway (S-GW), and the St-MME interface, which is a signaling interface between the base station 1012 or base station 1014 and mobility management entities (MMEs).

In embodiments, the CN 1024 may be a 5GC, and the RAN 1006 may be connected with the CN 1024 via an NG interface 1028. In embodiments, the NG interface 1028 may be split into two parts, an NG user plane (NG-U) interface, which carries traffic data between the base station 1012 or base station 1014 and a user plane function (UPF), and the S1 control plane (NG-C) interface, which is a signaling interface between the base station 1012 or base station 1014 and access and mobility management functions (AMFs).

Generally, an application server 1030 may be an element offering applications that use internet protocol (IP) bearer resources with the CN 1024 (e.g., packet switched data services). The application server 1030 can also be configured to support one or more communication services (e.g., VoIP sessions, group communication sessions, etc.) for the UE 1002 and UE 1004 via the CN 1024. The application server 1030 may communicate with the CN 1024 through an IP communications interface 1032.

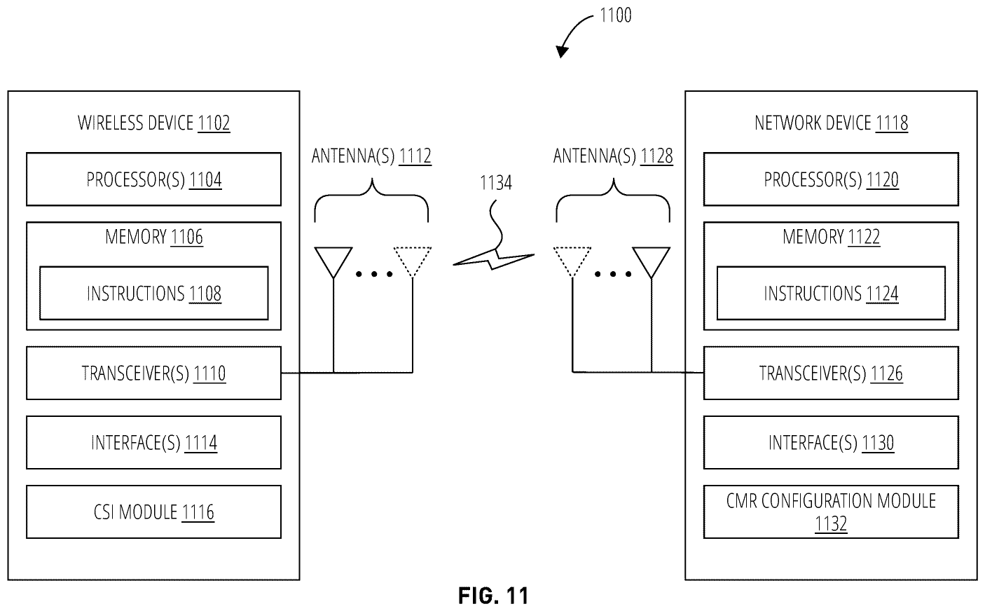

FIG. 11 illustrates a system 1100 for performing signaling 1134 between a wireless device 1102 and a network device 1118, according to embodiments disclosed herein. The system 1100 may be a portion of a wireless communications system as herein described. The wireless device 1102 may be, for example, a UE of a wireless communication system. The network device 1118 may be, for example, a base station (e.g., an eNB or a gNB) of a wireless communication system.

The wireless device 1102 may include one or more processor(s) 1104. The processor(s) 1104 may execute instructions such that various operations of the wireless device 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The wireless device 1102 may include one or more transceiver(s) 1110 that may include radio frequency (RF) transmitter and/or receiver circuitry that use the antenna(s) 1112 of the wireless device 1102 to facilitate signaling (e.g., the signaling 1134) to and/or from the wireless device 1102 with other devices (e.g., the network device 1118) according to corresponding RATs.

The wireless device 1102 may include one or more antenna(s) 1112 (e.g., one, two, four, or more). For embodiments with multiple antenna(s) 1112, the wireless device 1102 may leverage the spatial diversity of such multiple antenna(s) 1112 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1102 may be accomplished according to precoding (or digital beamforming) that is applied at the wireless device 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The wireless device 1102 may include one or more interface(s) 1114. The interface(s) 1114 may be used to provide input to or output from the wireless device 1102. For example, a wireless device 1102 that is a UE may include interface(s) 1114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The wireless device 1102 may include a CSI module 1116. The CST module 1116 may be implemented via hardware, software, or combinations thereof. For example, the CSI module 1116 may be implemented as a processor, circuit, and/or instructions 1108 stored in the memory 1106 and executed by the processor(s) 1104. In some examples, the CSI module 1116 may be integrated within the processor(s) 1104 and/or the transceiver(s) 1110. For example, the CSI module 1116 may be implemented by a combination of software components (e.g., executed by a DSP or a general processor) and hardware components (e.g., logic gates and circuitry) within the processor(s) 1104 or the transceiver(s) 1110.

The CSI module 1116 may be used for various aspects of the present disclosure, for example, aspects of FIGS. 1-9. The CSI module 1116 is configured to provide Multi-TRP Coherent Joint Transmission CSI feedback.

The network device 1118 may include one or more processor(s) 1120. The processor(s) 1120 may execute instructions such that various operations of the network device 1118 are performed, as described herein. The processor(s) 1120 may include one or more baseband processors implemented using, for example, a CPU, a DSP, an ASIC, a controller, an FPGA device, another hardware device, a firmware device, or any combination thereof configured to perform the operations described herein.

The network device 1118 may include a memory 1122. The memory 1122 may be a non-transitory computer-readable storage medium that stores instructions 1124 (which may include, for example, the instructions being executed by the processor(s) 1120). The instructions 1124 may also be referred to as program code or a computer program. The memory 1122 may also store data used by, and results computed by, the processor(s) 1120.

The network device 1118 may include one or more transceiver(s) 1126 that may include RF transmitter and/or receiver circuitry that use the antenna(s) 1128 of the network device 1118 to facilitate signaling (e.g., the signaling 1134) to and/or from the network device 1118 with other devices (e.g., the wireless device 1102) according to corresponding RATs.

The network device 1118 may include one or more antenna(s) 1128 (e.g., one, two, four, or more). In embodiments having multiple antenna(s) 1128, the network device 1118 may perform MIMO, digital beamforming, analog beamforming, beam steering, etc., as has been described.

The network device 1118 may include one or more interface(s) 1130. The interface(s) 1130 may be used to provide input to or output from the network device 1118. For example, a network device 1118 that is a base station may include interface(s) 1130 made up of transmitters, receivers, and other circuitry (e.g., other than the transceiver(s) 1126/antenna(s) 1128 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1118 may include a CMR configuration module 1132. The CMR configuration module 1132 may be implemented via hardware, software, or combinations thereof. For example, the CMR configuration module 1132 may be implemented as a processor, circuit, and/or instructions 1124 stored in the memory 1122 and executed by the processor(s) 1120. In some examples, the CMR configuration module 1132 may be integrated within the processor(s) 1120 and/or the transceiver(s) 1126. For example, the CMR configuration module 1132 may be implemented by a combination of software components (e.g., executed by a DSP or a general processor) and hardware components (e.g., logic gates and circuitry) within the processor(s) 1120 or the transceiver(s) 1126.

The CMR configuration module 1132 may be used for various aspects of the present disclosure, for example, aspects of FIGS. 1-9. The CMR configuration module 1132 is configured to generate CMR configuration to support Multi-TRP Coherent Joint Transmission CSI feedback.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a network node, the method comprising:
generating a Channel Measurement Resource (CMR) configuration to support a multiple transmission and reception point (Multi-TRP) Coherent Joint Transmission (CJT) Channel State Information (CSI) report;
sending the CMR configuration to a UE, wherein the CMR configuration associates the multi-TRP CJT CSI report with one resource set comprising one or more resources, wherein each of the one or more resources comprise multiple ports, and wherein the CMR configuration indicates a mapping of the multiple ports to a plurality of TRPs;
sending one or more Channel State Information Reference Signals (CSI-RSs) to the UE;
receiving, from the UE, the multi-TRP CJT CSI report; and
sending, to the UE, a transmission based on the multi-TRP CJT CSI report.

2. The method of claim 1, wherein the mapping is hard coded.

3. The method of claim 1, wherein the mapping is configured by the network node.

4. The method of claim 1, wherein the CMR configuration further comprises an antenna configuration for the plurality of TRPs that the UE uses to determine the mapping.

5. The method of claim 4, wherein the antenna configuration of each TRP is the same.

6. The method of claim 4, wherein the antenna configuration of at least one TRP is different than other TRPs.

7. The method of claim 1, wherein the mapping of the multiple ports to the plurality of TRPs is determined sequentially.

8. The method of claim 1, wherein the mapping of the multiple ports to the plurality of TRPs is explicitly configured by the network node.

9. The method of claim 1, wherein ports in a same CDM group are grouped together associated with a same TRP by the mapping.

10-20. (canceled)

21. A method for a user equipment (UE), the method comprising:
receiving a Channel Measurement Resource (CMR) configuration to support a multiple transmission and reception point (Multi-TRP) Coherent Joint Transmission (CJT) Channel State Information (CSI) report, wherein the CMR configuration associates the multi-TRP CJT CSI report with one resource set comprising one or more resources, wherein each of the one or more resources comprise multiple ports, and wherein the CMR configuration indicates a mapping of the multiple ports to a plurality of TRPs;
receiving one or more Channel State Information Reference Signals (CSI-RSs) from the plurality of TRPs; and
reporting, to a network node, the multi-TRP CJT CSI report.

22. The method of claim 21, wherein the mapping is hard coded.

23. The method of claim 21, wherein the mapping is configured by the network node.

24. The method of claim 21, wherein the CMR configuration further comprises an antenna configuration for the plurality of TRPs that the UE uses to determine the mapping.

25. The method of claim 24, wherein the antenna configuration of each TRP is the same.

26. The method of claim 24, wherein the antenna configuration of at least one TRP is different than other TRPs.

27. The method of claim 21, wherein the mapping of the multiple ports to the plurality of TRPs is determined sequentially.

28. The method of claim 21, wherein the mapping of the multiple ports to a plurality of TRPs is explicitly configured by the network node.

29. The method of claim 21, wherein ports in a same CDM group are grouped together associated with a same TRP by the mapping.

30. A method for a user equipment (UE), the method comprising:
receiving a Channel Measurement Resource (CMR) configuration to support a multiple transmission and reception point (Multi-TRP) Coherent Joint Transmission (CJT) Channel State Information (CSI) report, wherein the CMR configuration associates the multi-TRP CJT CSI report with one resource set comprising a plurality of resources, and wherein the CMR configuration associates each of the plurality of resources with one of a plurality of TRPs;
receiving one or more Channel State Information Reference Signals (CSI-RSs from the plurality of TRPs; and
reporting, to a network node, the multi-TRP CJT CSI report.

31. The method of claim 30, wherein the CMR configuration individually configures one or more than one resources to share a same TRP, and wherein the multi-TRP CJT CSI report includes a preferred resource for each TRP independently.

32-43. (canceled)
